(19) United States
(12) Patent Application Publication
(10) Pub. No.: US 2020/0311703 A1
(43) Pub. Date: Oct. 1, 2020

(54) METHODS AND SYSTEMS FOR KIOSK DEVICE

(71) Applicant: Christopher Shawn Fellows, Oxford, GA (US)

(72) Inventor: Christopher Shawn Fellows, Oxford, GA (US)

(21) Appl. No.: 16/831,446

(22) Filed: Mar. 26, 2020

Related U.S. Application Data
(60) Provisional application No. 62/824,159, filed on Mar. 26, 2019.

(51) Int. Cl. G06Q 20/18; G07F 11/00; G06Q 20/20

(52) U.S. Cl. CPC G06Q 20/18; G06Q 20/204; G07F 11/002

(57) ABSTRACT

Methods, systems, and apparatuses for a kiosk device are described herein. A computing device may determine an account associated with a user. The computing device may provide information associated with the account to the user. A plurality of items for purchase may be displayed. The computing device may receive an indication of a selection of items for purchase from the user. The computer device may provide a plurality of purchase options for the selected one or more items. The computing device may receive an indication of a selected purchase option. Purchase of the selected one or more items may be executed based on the a selected purchase option.

### CROSS REFERENCE TO RELATED APPLICATION

This application claims the benefit of U.S. Provisional Patent Application No. 62/824,159, filed Mar. 26, 2019, the content of which application is hereby incorporated by reference in its entirety.

### BACKGROUND

Typically, if a person wishes to purchase or redeem tokens at a place of business, the person needs to interact with personnel at the place of business. However, this can be time consuming if the place of business is very busy. Further, the place of business may not have the item the user desires in stock.

### SUMMARY

It is to be understood that both the following general description and the following detailed description are exemplary and explanatory only and are not restrictive, as claimed. Provided are method, systems, and apparatuses for a kiosk device.

In one embodiment, a method comprises determining an account associated with a user. A computing device can determine the account associated with the user. The method also comprises providing information associated with the account to the user. The method further comprises displaying a plurality of items for purchase. The method also comprises receiving from the user an indication of a selection of one or more of the plurality of items for purchase. The method additionally comprises providing a plurality of purchase options for the selected one or more items. The method also comprises receiving from the user an indication of a selected purchase option of the plurality of purchase options. Additionally, the method comprises executing the purchase of the selected one or more items based on the selected purchase option.

In another embodiment, a system comprises a display, a card reader, a cash acceptor, an image scanner, one or more processors, and a memory. The display can be configured to receive input from a user. The card reader can be configured to read information associated with a credit card. The cash acceptor can be configured to accept physical money comprising at least one of bills or coins. The image scanner can be configured to scan at least one of a barcode or a quick reference code. The memory can store processor executable instructions that, when executed by the one or more processors, cause the system to determine an account associated with the user. The system can also provide information associated with the account to the user. The system can provide a plurality of items for purchase. The system can receive an indication of a selection of one or more of the plurality of items for purchase. The system can also provide a plurality of purchase options for the selected one or more items. The system can receive an indication of a selected purchase option of the plurality of purchase options. The system can also receive a payment associated with the selected purchase option. Additionally, the system can execute purchases of the selected one or more items. The system can also comprise a server, printer, and a network router. The server can be a database server, web server, or the like in order to provide services such as network related services, purchasing services, and reporting services. The printer can be any printer capable of printing information. The network router can provide access to a networked environment.

In a further embodiment, an apparatus can comprise one or more processors and a memory. The memory can store processor executable instructions that, when executed by the one or more processors, cause the apparatus to determine an account associated with the user. The apparatus can also provide information associated with the account to the user. The apparatus can provide a plurality of items for purchase. The apparatus can receive an indication of a selection of one or more of the plurality of items for purchase. The apparatus can also provide a plurality of purchase options for the selected one or more items. The apparatus can receive an indication of a selected purchase option of the plurality of purchase options. The apparatus can also receive a payment associated with the selected purchase option. Additionally, the apparatus can execute the purchase of the selected one or more items.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a diagram illustrating an exemplary system;

FIG. 2 is a block diagram illustrating an exemplary system;

FIG. 3 is a block diagram illustrating an exemplary system;

FIG. 4 is a flowchart illustrating an exemplary method; and

FIG. 5 is a block diagram illustrating an exemplary computing system.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Provided herein are methods and systems of using a kiosk to provide services to users in a variety of settings, such as gaming establishments, retail stores, amusement parks, etc. The kiosk may be designed to use a stored value account system such as those utilized in the coin operated amusement industry, gaming industry, and or retail stores seeking to expand the variety of products offered to their patrons. The kiosk may utilize a card reader, online registration, online login, touchscreen display, and/or other methodology to access a stored value account. A user of the kiosk may be required to complete registration at the kiosk in order to create a stored value account. Registration may require the user's mobile phone number and/or email address. The user may register at the kiosk using a touchscreen or similar interface of the kiosk. The user may be prompted to register upon inserting a card into the kiosk, such as via the card reader. For example, the kiosk may determine that the user's card is a new player card requiring registration and consequently may prompt the user to input user information via the kiosk interface. When a stored value account (e.g, associated with the player card and user) is created via the registration, the user may access corresponding information including balance information, transaction information, order information, profile information and the like. The user associated with the stored value account may access a series of products (e.g., via the Internet) or items stored in a memory of the kiosk. The memory of the kiosk may include a database comprising a plurality of records associated with purchases and stored value accounts of one or more users. Access to the database of the kiosk may be based on a database server of the kiosk. The products and/or items may be purchased and/or claimed as a prize for credits in the stored value account.

The user may access the stored value account by entering a unique account number, inserting their card, tapping their card, and or other methodology. The kiosk may prompt the user to enter a unique password or pin-code. Upon successfully logging into the kiosk, the touchscreen interface may display information related to the user, such as but not limited to a time, a date, a total stored value available, a date of last login, commonly selected items, an account balance prior to selection of items, a balance after redemption of prizes, a combination thereof and/or the like.

The user may select from a plurality of categories displayed at the kiosk and/or an item or items to be redeemed via the kiosk. The kiosk may prompt the user to select from the plurality of categories, which may include, for example, in store merchandise; gasoline, lottery products, apparel, bingo, food, cryptocurrency (e.g., bitcoins), a combination thereof and the like. The kiosk may also provide categories that allow the user to select from a series of online products. That is, the user may make purchases from the plurality of categories, including the online products or merchandise. The user may be able to utilize a portion and/or all of the stored value in the stored value account. The user may be provided with a total of selected products and utilize either credits associated with the stored value account, credit cards, cash, cryptocurrency and/or a combination thereof to provide payment for the selected products. The kiosk may print a receipt for the user and/or provide a proof of purchase through other electronic notification means, such as email or text message. The kiosk may also print a purchase ticket indicative of a purchase item and/or associated value of the item as well as print a redeem ticket to redeem one or more purchase items and/or stored value. The kiosk may process the selected items to be redeemed by the user and store the selections into the memory. The kiosk may be used at venues associated with the gaming/gambling industry to cash-out and/or redeem winning tickets from gaming play associated with a user. The kiosk may be used in relationship with a rewards program. The kiosk may provide, via the touchscreen interface, a view of a virtual library of prizes that may be selected and purchased using credits associated with the rewards program.

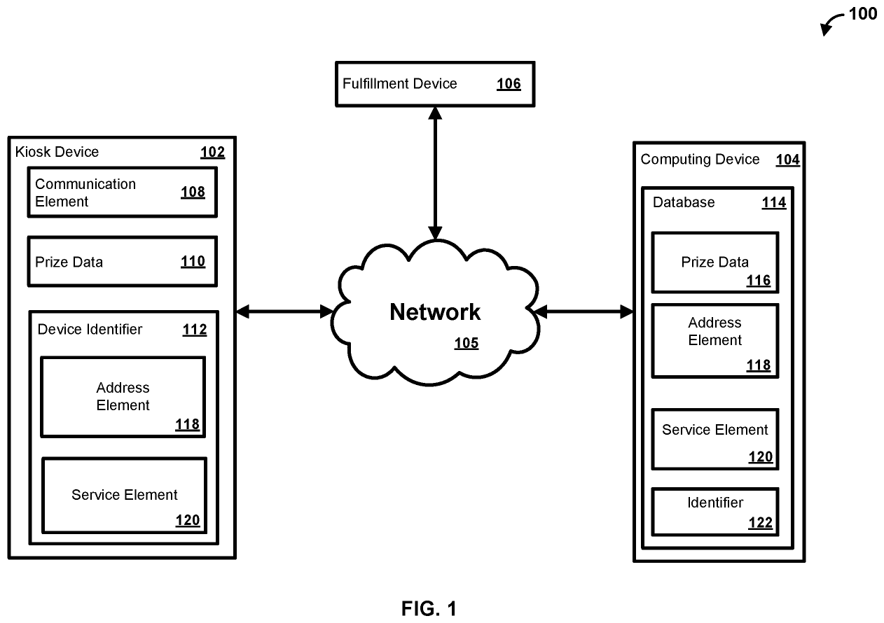

FIG. 1 illustrates a system 100. The system 100 can comprise one or more kiosk devices 102, computing devices 104, and/or fulfillment devices 106. The computing device 104 may be disposed locally or remotely relative to the kiosk device 102. As an example, the kiosk device 102 and the computing device 104 may be in communication via a private and/or public network 105 such as the Internet or a local area network. Other forms of communications may be used such as wired and wireless telecommunication channels, for example.

In an example, the kiosk device 102 may be an electronic device such as a computer, a smartphone, a laptop, a tablet, a kiosk, a display device, or other device capable of communicating with the computing device 104. As an example, the kiosk device 102 may comprise a communication element 108 for providing an interface to a user to interact with the kiosk device 102. The communication element 108 may be any interface for presenting and/or receiving information to/from the user, such as user feedback, user selections, and/or interactions with the kiosk device 102. An example interface may be a communication interface such as a web browser (e.g., Internet Explorer, Mozilla Firefox, Google Chrome, Safari, or the like) or another graphical interface for receiving indications from a user. For example, the interface can include one or more elements that can be selected by a user. The one or more elements of the interface can cause the kiosk device 102 to perform one or more actions. Other software, hardware, and/or interfaces may be used to provide communication between the user and one or more of the kiosk device 102 and the computing device 104. As an example, the communication element 108 may facilitate a user purchasing one or more goods via the kiosk device 102. As another example, the communication element 108 may transmit data to the computing device 104 to facilitate the purchasing of the one or more goods. Additionally, the communication element 108 can transmit data to the fulfillment device 106 to facilitate the fulfillment device 106 providing the purchase goods to the user. For example, the communication element 108 may send data indicating acceptance of a payment option, such as one or more monetary bills inserted via a currency acceptor of the kiosk device 102, cards inserted via a card reader of the kiosk device 102, codes scanned by a scanner of the kiosk device 102.

In an example, the kiosk device 102 may be associated with a device identifier 112. As an example, the device identifier 112 may be any identifier, token, character, string, or the like, for differentiating one user or device (e.g., kiosk device 102) from another user or device. In a further example, the device identifier 112 may identify a user or kiosk device as belonging to a particular class of users or kiosk devices. As another example, the device identifier 112 may comprise information relating to the kiosk device 102 such as a manufacturer, a model or type of device, a service provider associated with the kiosk device 102, a state of the kiosk device 102, a locator, and/or a label or classifier. Other information may be represented by the device identifier 112.

In an example, the device identifier kiosk can comprise an address element 118 and a service element 120. In an example, the address element 118 may comprise or provide an internet protocol address, a network address, a media access control (MAC) address, an Internet address, or the like. As an example, the address element 118 may be relied upon to establish a communication session between the kiosk device 102 and the computing device 104 or other devices and/or networks. For example, the address element 118 may be used to facilitate execution of a purchase of items between the kiosk device 102 and the computing device 104. As a further example, the address element 118 may be used as an identifier or locator of the kiosk device 102. In an example, the address element 118 may be persistent for a particular network.

In an example, the service element 120 may comprise an identification provided by a service provider associated with the kiosk device 102 and/or with the class of kiosk device 102. The class of the kiosk device 102 may be related to a type of device, capability of device, type of service being provided, and/or a level of service (e.g., business class, service tier, service package, etc.). As an example, the service element 120 may comprise information relating to or provided by a communication service provider (e.g., Internet Service Provider) that is providing or enabling data flow such as communication services (e.g., an Internet connect) to the kiosk device 102. As a further example, the service element 120 may comprise information relating to a service provider for one or more particular services relating to the kiosk device 102. In an example, the address element 118 may be used to identify or retrieve data from the service element 120, or vice versa. As a further example, one or more of the address element 118 and the service element 120 may be stored remotely from the kiosk device 102 and retrieved by one or more devices such as the kiosk device 102 and the computing device 104. Other information may be represented by the service element 112. For example, the service element 120 can facilitate a user purchasing one or more goods via the kiosk device 102. As an example, the service element 120 can allow another device (e.g., the computing device 104) to communicate with the kiosk device 102 to provide information regarding purchasable goods, payment options, account information, and so forth to the kiosk device 102. The computing device 104 may be a remote network based (e.g, cloud based) device in communication with the kiosk device 102 or the computing device 104 may be integrated within or be a component of the kiosk device 102. For example, the computing device 104 may be an reporting server.

The kiosk device 102 can comprise prize data 110. The prize data 110 can include account information associated with one or more users. The prize data 110 can include information regarding one or more items available for purchase. The prize data 110 can also include information regarding one or more methods of payment for purchasing the one or more items available. The prize data 110 can also include information a redeem ticket printed by the kiosk device 102. The prize data 110 can facilitate a user completing a purchase via the kiosk device 102.

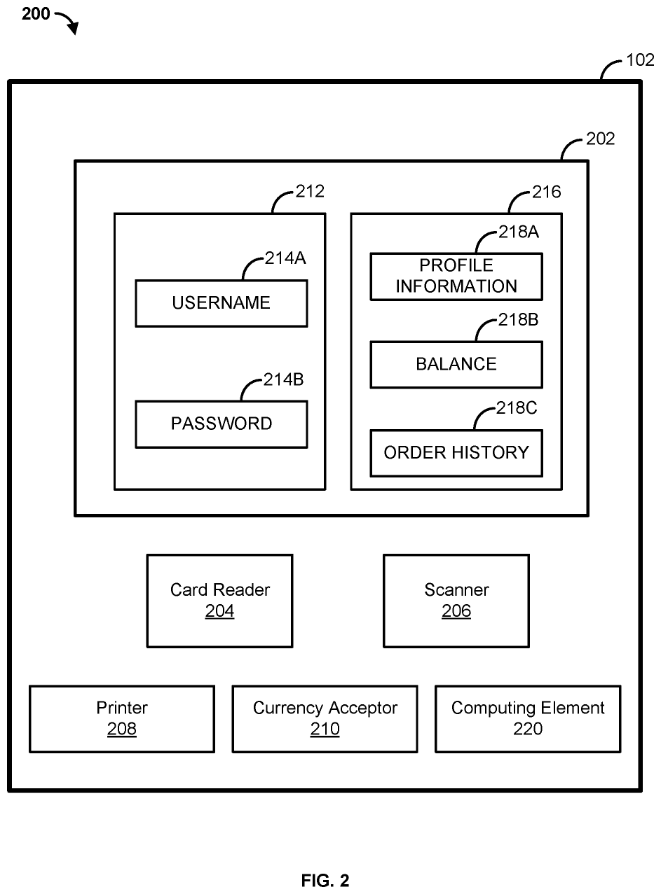

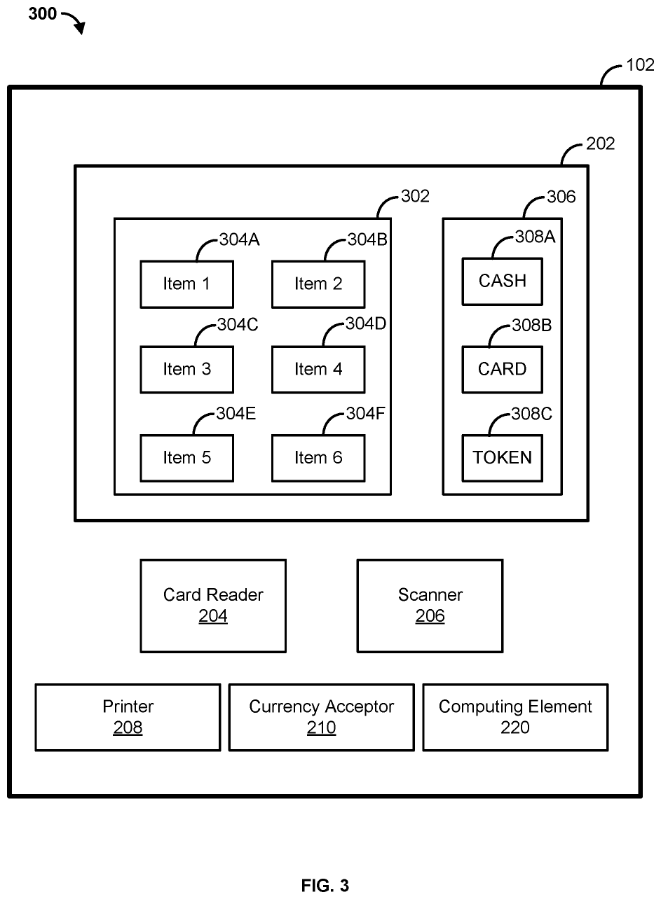

For example, the kiosk device 102 can determine the account associated with the user based on the prize data 110. The account may be determined based on login information (e.g., username, account number, password, etc.) provided by the user. The kiosk device 102 can search the prize data 110 to find a matching account based on the login information. The kiosk device 102 can then utilize the prize data 110 to determine information associated with the account. The kiosk device 102 can provide information associated with the account to the user. For example, the kiosk device 102 can provide the information associated with the account via a display (e.g., the display 202 of FIGS. 2 and 3). The kiosk device 102 can request a password associated with the account prior to providing the information associated with the account to the user. The information associated with the account can comprise an available balance of the account, a time of last login, previously completed purchases associated with the account, or commonly selected items.

The kiosk device 102 can utilize the prize data 110 to determine one or more items for purchase. For example, the prize data 110 can include information on all items available for purchase via the kiosk device 102. The prize data 110 can indicate that one or more items available for purchase are age restricted. Accordingly, the kiosk 102 can request additional information (e.g., age verification) from a user attempting to purchase an item that has an age restriction. The plurality of items for purchase can include merchandise associated with a merchant, automobile fuel, lottery products, apparel, food, and/or drinks.

The kiosk device 102 can utilize the prize data 110 to determine one or more purchase options for purchasing the selected one or more items. For example, the user accessing the kiosk device 102 may have one or more methods of payment stored in the prize data 110 such that the kiosk device 102 can determine a stored purchase option based on the prize data 110. The purchase options can include redemption credits (e.g., tickets such as purchase tickets or redeem tickets), a credit card, cash, or a cryptocurrency. The user may add value to the stored purchase option such as based on adding monetary value or other purchase credit to the user's card, which can be via a user device or the kiosk device 102, for example. As another example, the kiosk device 102 can utilize the prize data 110 to determine any purchase type restrictions associated with an item for sale. For example, the item for sale may only be purchasable using cash (e.g., a lottery ticket). The kiosk device 102 can utilize the prize data 110 to determine if there are any restrictions associated with the purchase method and provide that information to the user to facilitate the user properly purchasing the desired item.

The kiosk device 102 can utilize the prize data 110 to execute purchase of the items selected by the user. The kiosk device 102 can transmit data to another computing device (e.g., the computing device 104 and/or the fulfillment device 106) to indicate that the user has executed a purchase of the selected items. For example, the kiosk device 102 can provide an invoice associated with the executed purchase of the selected items to the computing device 104 and/or the fulfillment device 106. The kiosk device 102 may also sent data indicative of the purchase to an internal database server to store in an internal database similar to the database 114. That is, the database server and database may both be components of the kiosk device 102. The database of the kiosk device 102 may store all data relevant to purchases of the user as well as the user's account. In this situation, the kiosk device 102 may facilitate providing the selected items to the user. In other situations, the computing device 104 and/or the fulfillment device 106 can facilitate providing the selected items to the user. For example, the kiosk device 102, computing device 104 and/or the fulfillment device 106 can facilitate having the one or more items shipped to an address indicated by the user. As another example, the kiosk device 102, computing device 104 and/or the fulfillment device 106 can facilitate providing the selected items at a pickup location for the user to retrieve the selected items. The kiosk device 102 can provide the user with a proof of purchase that indicates the executed purchase of the selected items. For example, the kiosk device 102 can print via a printer (e.g., the printer 208 of FIGS. 2 and 3), a receipt that has the proof of purchase. As another example, the kiosk device 102 can provide an electronic receipt that indicates the proof of purchase. For example, the kiosk device 102 can store the electronic receipt in the prize data 110.

The kiosk device 102 can transmit the electronic receipt to another device (e.g., the computing device 104 or a user device of the user). The computing device 104 may generate reports based on the purchase and other kiosk activity, such as a sales tax report, user transaction report, debt report (e.g., how much money is owed or balance remains on products purchased by the user), list of users report (e.g., a list of users that have used the kiosk device 102), and the like. For example, depending on the location of the kiosk device 102 and the user, the user or administrator may log into the printer (e.g., the printer 208 of FIGS. 2 and 3) and print one or more of the generated reports. Some reports, such as the list of user report, may be unavailable to the user and only available to an administrator. The administrator may have administrative access to manage the kiosk device 102 and/or computing device 104, based on providing administrative access credentials, for example. As another example, the user or administrator may use a user interface, which may be part of the computing device 104, to access and view reports.

In an example, the computing device 104 may be a server for communicating with the kiosk device 102. As an example, the computing device 104 may communicate with the kiosk device 102 for providing data and/or services. As an example, the computing device 104 may provide services such as network (e.g., Internet) connectivity, network printing, media management (e.g., media server), content services, streaming services, broadband services, or other network-related services. The network connectivity may be used to place orders, such as to a store that is not located at the same location of the kiosk device 102, and to connect to a fulfillment system (e.g., fulfillment device 106).

As an example, the computing device 104 may be a remote (e.g., offsite relative to the kiosk device 102) reporting server that includes a database server, a web server, and a user interface. Users may interact with the user interface to access and view reports, for example, which may be generated by the web server based on information stored within the database server. The stored information may include a plurality of files (e.g., web pages), user identifiers or records, user profiles, prize data, purchase history, and the like. An administrator may have administrative access to manage the reporting server. A database corresponding to the database server may be synchronized according to the kiosk device 102 (e.g., based on a database or database server of the kiosk device 102) at a certain time interval. The time interval may be a periodic time period set by an administrator. In an example, the computing device 104 may allow the kiosk device 102 to interact with remote resources such as data, devices, and files. As an example, the computing device 104 may be configured as (or disposed at) a central location (e.g., a headend, or processing facility), which may receive content (e.g., data, input programming) from multiple sources. The computing device 104 may facilitate the purchasing of an item offered for sale via the kiosk device 102.

The computing device 104 can have a database 114. The database 114 can have prize data 116, an address element 118, a service element 120, and an identifier 122. The computing device 104 may manage the communication between the kiosk device 102 and the database 114 for sending and receiving data therebetween. The database 114 may store a plurality of files (e.g., web pages), user identifiers or records, user profiles, prize data 116, or other information. The kiosk device 102 may request and/or retrieve a file from the database 114. The database 114 may be a component of a database server which may be part of the kiosk device 102. The database 114 may store information relating to the kiosk device 102 such as the address element 118 and/or the service element 120. The computing device 104 may obtain the device identifier 112 from the kiosk device 102 and retrieve information from the database 114 such as the prize data 116, the address element 118, and/or the service elements 120. The computing device 104 may obtain the address element 118 from the kiosk device 102 and may retrieve the service element 120 from the database 114, or vice versa. Any information may be stored in and retrieved from the database 114. The database 114 may be disposed remotely from the computing device 104 and accessed via direct or indirect connection. The database 114 may be integrated with the computing device 104 or some other device or system. For example, the database 114 may instead be a component of the kiosk device 102.

The computing device 104 can comprise prize data 116. The prize data 116 can include account information associated with one or more users. The prize data 116 can include information regarding one or more items available for purchase. The prize data 116 can also include information regarding one or more methods of payment for purchasing the one or more items available. The prize data 116 can facilitate a user completing a purchase via the kiosk device 102.

For example, the computing device 104 can determine the account associated with the user based on the prize data 116. The account may be determined based on login information (e.g., username, account number, password, etc.) provided by the user. The computing device 104 can search the prize data 116 to find a matching account based on the login information. The computing device 104 can then utilize the prize data 116 to determine information associated with the account. The computing device 104 can provide information associated with the account to the user. For example, the computing device 104 can provide the information associated with the account to the kiosk device 102, which in turn provides the information to the user of the kiosk device 102. The computing device 104 can request a password associated with the account prior to providing the information associated with the account to the user. The information associated with the account can comprise an available balance of the account, a time of last login, previously completed purchases associated with the account, or commonly selected items. Other balance transactions, orders and profile information associated with the account may also be accessible to the user.

The computing device 104 can utilize the prize data 116 to determine one or more items for purchase. For example, the prize data 116 can include information on all items available for purchase via the kiosk device 102. The prize data 116 can indicate that one or more items available for purchase are age restricted. Accordingly, the computing device 104 can request additional information (e.g., age verification) from a user attempting to purchase an item that has an age restriction. The plurality of items for purchase can include merchandise associated with a merchant, automobile fuel, lottery products, apparel, bingo products, online merchandise, currency (e.g., cryptocurrency) food, and/or drinks and the like.

The computing device 104 can utilize the prize data 116 to determine one or more purchase options for purchasing the selected one or more items. For example, the user accessing the kiosk device 102 may have one or more methods of payment stored in the prize data 116 such that the computing device 104 can determine a stored purchase option based on the prize data 116. The purchase options can include redemption credits (e.g., tickets), a credit card, cash, or a cryptocurrency. The user may have the option of increasing the value of the purchase options, such as by adding monetary value via a card corresponding to the user's account. Based on the prize data 116, the user may receive a purchase ticket from the kiosk device 102 or the computing device 104 that indicates the purchasing power of the user or enables the user to purchase a subset of the plurality of items available for purchase. The purchase ticket may include a separate purchase ticket for items available at an online merchandise store. The user may also redeem the purchase ticket from a printer (e.g., the printer 208) or receive a redeem ticket from the printer. The redeem ticket may be used to redeem items available for purchase or stored value, for example. As another example, the computing device 104 can utilize the prize data 116 to determine any purchase type restrictions associated with an item for sale. For example, the item for sale may only be purchasable using cash (e.g., a lottery ticket). The computing device 104 can utilize the prize data 116 to determine if there are any restrictions associated with the purchase method and provide that information to the user to facilitate the user properly purchasing the desired item.

The computing device 104 can utilize the prize data 116 to execute purchase of the items selected by the user. The computing device 104 can receive data from another computing device (e.g., the kiosk device 102 and/or the fulfillment device 106) to indicate that the user has executed a purchase of the selected items. For example, the kiosk device 102 can provide an invoice associated with the executed purchase of the selected items to the computing device 104. The computing device 104 can then facilitate the purchase by updating the account and/or purchase method of the user to indicate that the user has purchased an item via the kiosk device 102. The computing device 104 can then facilitate providing the selected items to the user. For example, the computing device 104 can facilitate having the one or more items shipped to an address indicated by the user. As another example, the computing device 104 can facilitate providing the selected items at a pickup location for the user to retrieve the selected items.

For example, the computing device 104 can transmit an indication to the fulfillment device 106 that the user has purchased one or more items via the kiosk device 102. The computing device 104 may require internet connectivity to transmit the indication. The fulfillment device 106 can then facilitate providing the one or more purchased items to the user. The fulfillment device 106 may update the kiosk device 102 with the status of purchased item fulfillment. For example, the fulfillment device 106 may indicate when payment of the one or more purchased items is confirmed, when the order for one or more purchased items is sent out, or the like, so that the kiosk device 102 may resynchronize to reflect the updated fulfillment status. The fulfillment device 106 may also send status updates to the user as fulfillment of the one or more purchased items proceeds, such as via an email to a user device, for example. The computing device 104 can store information regarding a proof of purchase. For example, the kiosk device 102 can transmit an electronic receipt to computing device 104. The computing device 104 can then store the electronic receipt in the prize data 116.

The computing device 104 can facilitate an owner of the kiosk device 102 determining information related to the kiosk device 102. For example, the computing device 104 can store all transactions and/or data associated with the kiosk device 102 in the prize data 116. The owner of the kiosk device 102 can then request the data from the computing device 104. The computing device 104 can be capable of performing accounting associated with the kiosk device 102. The computing device 104 can be associated with a cloud service that facilitates the owner of the kiosk device 102 determining the information associated with the kiosk device 102.

The computing device 104 may be associated with an identifier 122. As an example, the identifier 122 may be any identifier, token, character, string, or the like, for differentiating one user or device (e.g., the computing device 104) from another user or device. In a further example, the identifier 122 may identify a user or computing device as belonging to a particular class of users or computing devices. As another example, the identifier 122 may comprise information relating to the computing device 104 such as a manufacturer, a model or type of device, a service provider associated with the computing device 104, a state of the computing device 104, a locator, and/or a label or classifier. Other information may be represented by the identifier 122.

The computing device 104 can comprise an address element 118 and a service element 120. In an example, the address element 118 may comprise or provide an internet protocol address, a network address, a media access control (MAC) address, an Internet address, or the like. As an example, the address element 118 may be relied upon to establish a communication session between the computing device 104 and the kiosk device 102 or other devices and/or networks. For example, the address element 118 may be used to facilitate execution of a purchase of items between the kiosk device 102 and the computing device 104. As a further example, the address element 118 may be used as an identifier or locator of the computing device 104. In an example, the address element 118 may be persistent for a particular network.

In an example, the service element 120 may comprise an identification provided by a service provider associated with the computing device 104 and/or with the class of computing device 104. The class of the computing device 104 may be related to a type of device, capability of device, type of service being provided, and/or a level of service (e.g., business class, service tier, service package, etc.). As an example, the service element 120 may comprise information relating to or provided by a communication service provider (e.g., Internet Service Provider) that is providing or enabling data flow such as communication services (e.g., an Internet connect) to the computing device 104. As a further example, the service element 120 may comprise information relating to a service provider for one or more particular services relating to the computing device 104. In an example, the address element 118 may be used to identify or retrieve data from the service element 120, or vice versa. As a further example, one or more of the address element 118 and the service element 120 may be stored remotely from the kiosk device 102 and retrieved by one or more devices such as the kiosk device 102 and the computing device 104. Other information may be represented by the service element 112.

FIG. 2 is a block diagram illustrating an exemplary system 200. As shown, the system 200 comprises a kiosk device 102 (e.g., the kiosk device of FIG. 1), a display 202, a card reader 204, a scanner 206, a printer 208, and a currency acceptor 210. The printer 208 can be any printer capable of printing information. For example, the printer 208 can be a receipt printer. As another example, the printer 208 may print tickets redeemable by a user for one or more items available for purchase.

The display 202 can be any type of display device. For example, the display 202 can be a touch screen that allows a user to interact with the display 202. The display 202 may provide one or more interface elements. For example, the display 202, as shown, provides a login element 212 and an account information element 216. The login element 212 can include a username element 214A and a password element 214B. A user can provide a user name and password via the username element 214A and the password element 214B to access an account associated with the user. The account information element 216 can include profile information 218A, balance 218B, and order history 218C. For example, the prize data 110 of FIG. 1 can provide the information associated with the login element 212 and the account information element 216.

The card reader 204 can be any device capable of reading a card. For example, the card reader 204 can be a credit card reader that is capable of determining information from a credit card. As an example, the card reader 204 can be capable of determining information from a magnetic strip, embedded or integrated circuit chip, and/or barcode associated with a credit card. The card reader 204 can generally be capable of reading data from any smart card. As another example, the card reader 204 can be capable of determining information from a currency card associated with a place of business. The currency card may indicate the balance of currency that a person in possession of the currency card has at a place of business. The currency can be tokens, chips, and so forth that are only redeemable at a specific retailer.

The scanner 206 can be any device capable of scanning information. For example, the scanner 206 can be able to scan a barcode or Quick Response (QR) code. The scanner 206 can also be capable of scanning one or more images. For example, the scanner 206 can be capable of scanning a document that indicates a proof of purchase or currency balance. As another example, the scanner 206 can be capable of scanning a ticket such as a redeem ticket or purchase ticket via a corresponding optical code.

The currency acceptor 210 can be capable of accepting any type of currency. For example, the currency acceptor 210 can accept bills, coins, tokens, and so forth. The currency acceptor 210 can accept the currency, read the currency, and determine a value amount associated with the currency.

The computing element 220 may include one or more computing device or processors to process data and actions associated with a user account and purchase items/options. The computing element 220 may include a network router to provide access to a network, such as the Internet. For example, the computing element 220 may provide access to the fulfillment device 106 and/or the computing device 104, either of which may be remote from the kiosk device 102. For example, the fulfillment device 106 may provide access to an online store offering merchandise that is not associated with the kiosk device 102. The computing element 220 may include a database server in communication with a database, which may be similar to the database 114, for example.

FIG. 3 is a block diagram illustrating an exemplary system 300. The system 300 comprises the kiosk device 102, but with different interface elements shown. The display 202 comprises a plurality of items for purchase 302 and a plurality of purchase options 306. Specifically, the plurality of items for purchase 302 comprises items 304A,B,C,D,E,F available for purchase. The plurality of purchase options 306 comprises a cash option 308A, a card option 308, and a token option 308C. The token option 308C may include purchase tickets, redeem tickets, and/or indicators of prizes for credits in the stored value account. A user may interact with the kiosk device 102 to select from the plurality of items for purchase 302. The user can also interact with the kiosk device 102 to select at least one of the plurality of purchase options 306 to facilitate purchasing the items.

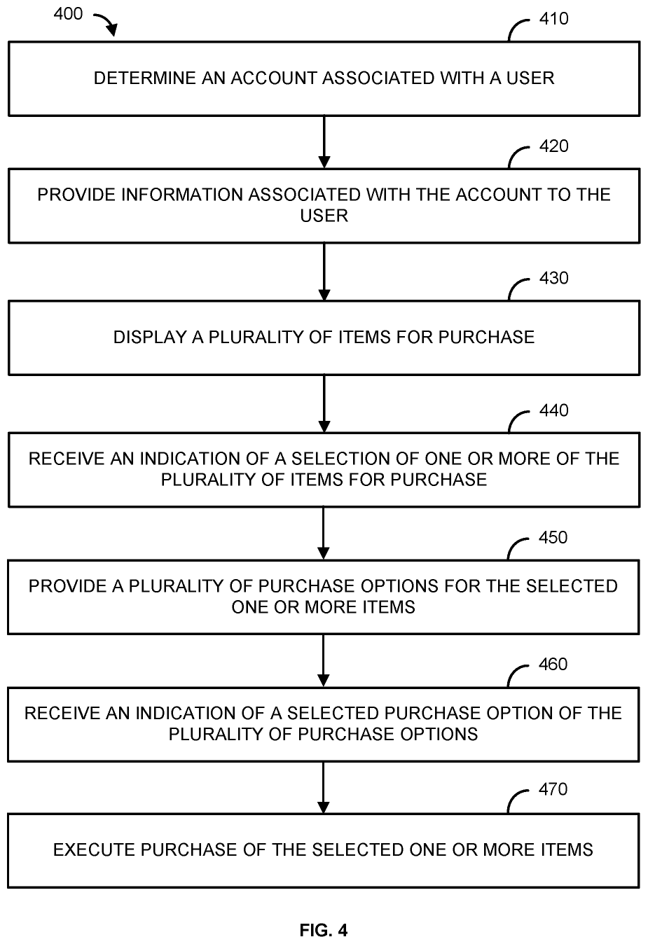

FIG. 4 is a flowchart of an example method 400. At step 410, an account associated with a user is determined. For example, the kiosk device 102 and/or the computing device 104 of FIG. 1 can determine the account associated with the user. The account may be determined based on login information (e.g., username, account number, password, etc.) provided by the user.

At step 420, information associated with the account is provided to the user. For example, the kiosk device 102 of FIGS. 1, 2, & 3 can provide the information associated with the account. The kiosk device 102 can provide the information associated with the account via a display (e.g., the display 202 of FIGS. 2 and 3). The kiosk device 102 can request a password associated with the account prior to providing the information associated with the account to the user. The information associated with the account can comprise an available balance of the account, a time of last login, previously completed purchases associated with the account, or commonly selected items.

At step 430, a plurality of items for purchase are displayed. For example, the kiosk device 102 can provide the information associated with the account via the display (e.g., the display 202 of FIGS. 2 and 3). The plurality of items for purchase can include merchandise associated with a merchant, automobile fuel, lottery products, apparel, food, or drinks.

At step 440, an indication of a selection of one or more of the plurality of items for purchase is received. For example, the kiosk device 102 of FIGS. 1, 2, & 3 can receive the indication from the user. The indication can be received via the display 202. The indication may indicate that the user has interacted with the display 202 (e.g., touched the display) to designate the selection of the items.

At step 450, a plurality of purchase options for the selected one or more items can be provided. For example, the kiosk device 102 of FIGS. 1, 2, & 3 can provide the plurality of purchase options. The plurality of purchase options can be displayed on the display. The plurality of purchase options can include redemption credits (e.g., tickets), a credit card, cash, or a cryptocurrency.

At step 460, an indication of a selected purchase option of the plurality of purchase options is received. For example, the kiosk device 102 of FIGS. 1, 2, & 3 can receive the indication from the user.

At step 470, purchase of the selected one or more items is executed. For example, the kiosk device 102 of FIGS. 1, 2, & 3 can execute the purchase. As an example, the kiosk device 102 can transmit data to another computing device (e.g., the computing device 104 and/or the fulfillment device 106 of FIG. 1) to indicate that the user has executed a purchase of the selected items. For example, the kiosk device 102 can provide an invoice associated with the executed purchase of the selected items to the computing device. As another example, the kiosk device 102 may directly provide an invoice, report, or other account or purchase information to the user. The computing device can then facilitate providing the selected items to the user. For example, the computing device can facilitate having the one or more items shipped to an address indicated by the user. As another example, the computing device can facilitate providing the selected items at a pickup location for the user to retrieve the selected items. The kiosk device 102 can provide the user with a proof of purchase that indicates the executed purchase of the selected items. For example, the kiosk device 102 can print via a printer (e.g., the printer 208 of FIGS. 2 and 3) a receipt that has the proof of purchase. As another example, the kiosk device 102 can provide an electronic receipt that indicates the proof of purchase.

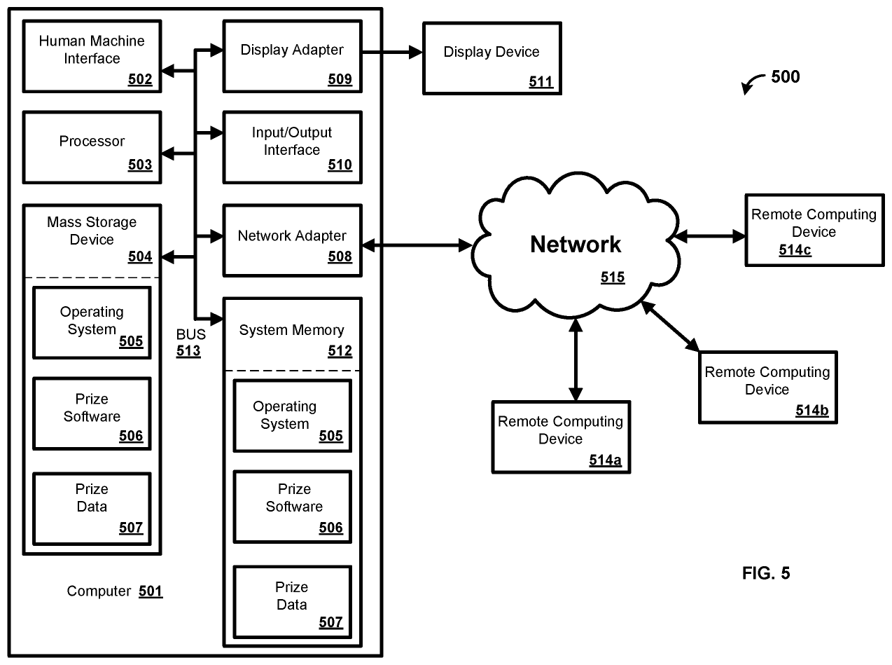

FIG. 5 is a block diagram showing an example of an operating environment 500 for performing the described methods. An example computer 501 may be configured to perform any of the methods and/or systems described herein. By way of example, the kiosk device 102, the computing device 104, and/or the fulfillment device 106 of FIG. 1 may be a computer as shown in FIG. 5. Similarly, the methods and systems described may utilize one or more computers to perform one or more functions in one or more locations. The example of the operating environment provided is only an example of an operating environment and is not intended to suggest any limitation as to the scope of use or functionality of operating environment architecture. Neither should the operating environment be interpreted as having any dependency or requirement relating to any one or combination of components shown in the example of the operating environment.

The present methods and systems may be operational with numerous other general purpose or special purpose computing system environments or configurations. Examples of well-known computing systems, environments, and/or configurations that may be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the described methods and systems may be performed by software components. The described systems and methods may be described in the general context of computer-executable instructions, such as program modules, being executed by one or more computers or other devices. Generally, program modules comprise computer code, routines, programs, objects, components, data structures, etc., that perform particular tasks or implement particular abstract data types. The described methods may also be practiced in grid-based and distributed computing environments where tasks are performed by remote processing devices that are linked through a communications network. In a distributed computing environment, program modules may be located in both local and remote computer storage media including memory storage devices.

Further, one skilled in the art will appreciate that the systems and methods described herein may be implemented via a general-purpose computing device in the form of a computer 501. The components of the computer 501 may comprise, but are not limited to, one or more processors 503, a system memory 512, and a system bus 513 that couples various system components including the one or more processors 503 to the system memory 512. The system 500 may utilize parallel computing.

The system bus 513 represents one or more of several possible types of bus structures, including a memory bus or memory controller, a peripheral bus, an accelerated graphics port, or local bus using any of a variety of bus architectures. By way of example, such architectures may comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The system bus 513, and all buses specified in this description, may also be implemented over a wired or wireless network connection and each of the subsystems, including the one or more processors 503, a mass storage device 504, an operating system 505, prize software 506, prize data 507, a network adapter 508, the system memory 512, an Input/Output Interface 510, a display adapter 509, a display device 511, and a human machine interface 502, may be contained within one or more remote computing devices 514a,b,c at physically separate locations, connected through buses of this form, in effect implementing a fully distributed system.

The computer 501 typically comprises a variety of computer readable media. Exemplary readable media may be any available media that is accessible by the computer 501 and comprises, for example and not meant to be limiting, both volatile and non-volatile media, removable and non-removable media. The system memory 512 comprises computer readable media in the form of volatile memory, such as random access memory (RAM), and/or non-volatile memory, such as read only memory (ROM). The system memory 512 typically contains data such as the prize data 507 and/or program modules such as the operating system 505 and the prize software 506 that are immediately accessible to and/or are presently operated on by the one or more processors 503.

The computer 501 may also comprise other removable/non-removable, volatile/non-volatile computer storage media. By way of example, FIG. 5 shows the mass storage device 504 which may provide non-volatile storage of computer code, computer readable instructions, data structures, program modules, and other data for the computer 501. For example, and not meant to be limiting, the mass storage device 504 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules may be stored on the mass storage device 504, including by way of example, the operating system 505 and the prize software 506. The prize data 507 may also be stored on the mass storage device 504. The prize data 507 may be stored in any of one or more databases known in the art. Examples of such databases comprise, DB2®, Microsoft® Access, Microsoft® SQL Server, Oracle®, mySQL, PostgreSQL, and the like. The databases may be centralized or distributed across multiple systems.

The user may enter commands and information into the computer 501 via an input device (not shown). Examples of such input devices comprise, but are not limited to, a keyboard, pointing device (e.g., a “mouse”), a microphone, a joystick, a scanner, tactile input devices such as gloves, and other body coverings, and the like. These and other input devices may be connected to the one or more processors 503 via the human machine interface 502 that is coupled to the system bus 513, but may be connected by other interface and bus structures, such as a parallel port, game port, an IEEE 1394 Port (also known as a Firewire port), a serial port, or a universal serial bus (USB).

The display device 511 may also be connected to the system bus 513 via an interface, such as the display adapter 509. It is contemplated that the computer 501 may have more than one display adapter 509 and the computer 501 may have more than one display device 511. For example, the display device 511 may be a monitor, an LCD (Liquid Crystal Display), or a projector. In addition to the display device 511, other output peripheral devices may comprise components such as speakers (not shown) and a printer (not shown) which may be connected to the computer 501 via the Input/Output Interface 510. Any step and/or result of the methods may be output in any form to an output device. Such output may be any form of visual representation, including, but not limited to, textual, graphical, animation, audio, tactile, and the like. The display device 511 and computer 501 may be part of one device, or separate devices.

The computer 501 may operate in a networked environment using logical connections to one or more remote computing devices 514a,b,c. By way of example, a remote computing device may be a personal computer, portable computer, smartphone, a server, a router, a network computer, a peer device or other common network node, and so on. Logical connections between the computer 501 and a remote computing device 514a,b,c may be made via a network 515, such as a local area network (LAN) and/or a general wide area network (WAN). Such network connections may be through the network adapter 508. The network adapter 508 may be implemented in both wired and wireless environments. Such networking environments are conventional and commonplace in dwellings, offices, enterprise-wide computer networks, intranets, and the Internet.

For ease of explanation, application programs and other executable program components such as the operating system 505 are shown herein as discrete blocks, although it is recognized that such programs and components reside at various times in different storage components of the computing device 501, and are executed by the one or more processors 503 of the computer. An implementation of the prize software 506 may be stored on or transmitted across some form of computer readable media. Any of the described methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

The methods and systems may employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g., genetic algorithms), swarm intelligence (e.g., ant algorithms), and hybrid intelligent systems (e.g., Expert inference rules generated through a neural network or production rules from statistical learning).

While the methods and systems have been described in connection with specific examples, it is not intended that the scope be limited to the particular examples set forth, as the examples herein are intended in all respects to be possible examples rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of examples described in the specification.

It will be apparent to those skilled in the art that various modifications and variations may be made without departing from the scope or spirit. Other examples will be apparent to those skilled in the art from consideration of the specification and practice described herein. It is intended that the specification and examples be considered as exemplary only, with a true scope and spirit being indicated by the following claims.

What is claimed is:

1. A method, comprising:
determining, by a computing device, an account associated with a user;
providing, by the computing device, information associated with the account to the user;
displaying a plurality of items for purchase;
receiving, by the computing device from the user, an indication of a selection of one or more of the plurality of items for purchase;
providing a plurality of purchase options for the selected one or more items;
receiving, by the computing device from the user, an indication of a selected purchase option of the plurality of purchase options; and
executing, based on the selected purchase option, purchase of the selected one or more items.

2. The method of claim 1, further comprising requesting a password associated with the account prior to providing the information associated with the account to the user.

3. The method of claim 1, wherein the information associated with the account comprises at least one of an available balance of the account, a time of last login, previously completed purchases associated with the account, or commonly selected items.

4. The method of claim 1, wherein the plurality of items for purchase comprises at least one of merchandise associated with a merchant, automobile fuel, lottery products, apparel, food, or drinks.

5. The method of claim 1, wherein the plurality of purchase options comprises at least one of redemption credits, a credit card, cash, or a cryptocurrency.

6. The method of claim 1, further comprising providing, to the user, a proof of purchase that indicates the executed purchase of the selected one or more items.

7. The method of claim 1, further comprising providing, to a fulfillment device, an invoice associated with the executed purchase of the selected one or more items, wherein the fulfillment device facilitates providing the selected one or more items at a pickup location for the user to retrieve the selected one or more items.

8. A system, comprising:
a display configured to receive input from a user;
a card reader configured to read information associated with a credit card;
a cash acceptor configured to accept physical money comprising at least one of bills or coins;
an image scanner configured to scan at least one of a barcode or a quick reference code;
one or more processors; and
a memory storing processor executable instructions that, when executed by the one or more processors, cause the system to:
determine an account associated with the user;
provide, via the display, information associated with the account to the user;
provide, via the display, a plurality of items for purchase;
receive, from the user via the display, an indication of a selection of one or more of the plurality of items for purchase;
provide, via the display, a plurality of purchase options for the selected one or more items;
receive, from the user via the display, an indication of a selected purchase option of the plurality of purchase options;
receive, via at least one of the card reader, the cash acceptor or the image scanner, a payment associated with the selected purchase option; and
execute, based on the provided payment, purchase of the selected one or more items.

9. The system of claim 8, wherein the processor executable instructions, when executed by the one or more processors, further cause the system to request a password associated with the account prior to providing the information associated with the account to the user.

10. The system of claim 8, wherein the information associated with the account comprises at least one of an available balance of the account, a time of last login, previously completed purchases associated with the account, or commonly selected items.

11. The system of claim 8, wherein the plurality of items for purchase comprises at least one of merchandise associated with a merchant, motor vehicle fuel, lottery products, apparel, food, or drinks.

12. The system of claim 8, wherein the plurality of purchase options comprises at least one of redemption credits, a credit card, cash, or a cryptocurrency.

13. The system of claim 8, further comprising a printer, and wherein the processor executable instructions, when executed by the one or more processors, further cause the system to provide, to the user via the printer, a proof of purchase that indicates the executed purchase of the selected one or more items.

14. The system of claim 8, further comprising providing, to a fulfillment device, an invoice associated with the executed purchase of the selected one or more items, wherein the fulfillment device facilitates providing the selected one or more items at a pickup location for the user to retrieve the selected one or more items.

15. An apparatus, comprising:
one or more processors; and
a memory storing processor executable instructions that, when executed by the one or more processors, cause the apparatus to:
determine an account associated with a user;
provide information associated with the account to the user;
display a plurality of items for purchase;
receive, from the user, an indication of a selected one or more of the plurality of items for purchase;
provide a plurality of purchase options for the selection of one or more items;
receive, from the user, an indication of a selected purchase option of the plurality of purchase options; and
execute, based on the selected purchase option, purchase of the selected one or more items.

16. The apparatus of claim 15, wherein the processor executable instructions, when executed by the one or more processors, further cause the apparatus to request a password associated with the account prior to providing the information associated with the account to the user.

17. The apparatus of claim 15, wherein the information associated with the account comprises at least one of an available balance of the account, a time of last login, previously completed purchases associated with the account, or commonly selected items.

18. The apparatus of claim 15, wherein the plurality of items for purchase comprises at least one of merchandise associated with a merchant, automobile fuel, lottery products, apparel, food, or drinks.

19. The apparatus of claim 15, wherein the plurality of purchase options comprises at least one of redemption credits, a credit card, cash, or a cryptocurrency.

20. The apparatus of claim 15, wherein the processor executable instructions, when executed by the one or more processors, further cause the apparatus to provide, to the user, a proof of purchase that indicates the executed purchase of the selected one or more items.
